(19) United States
(12) Patent Application Publication
(10) Pub. No.: US 2023/0408294 A1
(43) Pub. Date: Dec. 21, 2023

(54) UNSUPERVISED METADATA GENERATION FOR VEHICLE DATA LOGS

(71) Applicant: Atieva, Inc., Newark, CA (US)

(72) Inventor: Michael Anderson, Pleasanton, CA (US)

(21) Appl. No.: 18/338,834

(22) Filed: Jun. 21, 2023

Related U.S. Application Data
(60) Provisional application No. 63/366,729, filed on Jun. 21, 2022.

(51) Int. Cl. G01C 21/00; G06F 16/29; G07C 5/00

(52) U.S. Cl. CPC G01C 21/3856; G06F 16/29; G07C 5/008

(57) ABSTRACT

A method of performing unsupervised metadata generation for vehicle data comprises: receiving vehicle data collected during travel by a vehicle, the vehicle data including position data, speed data, and timestamps of the position data and the speed data; defining, using the vehicle data, a map route corresponding to the travel in map data; determining metadata for the travel using the map route; and annotating the vehicle data with the determined metadata.

### CROSS-REFERENCE TO RELATED APPLICATION

This application claims benefit, under 35 U.S.C. § 119, of U.S. Provisional Patent Application No. 63/366,729, filed on Jun. 21, 2022 and entitled “UNSUPERVISED METADATA GENERATION FOR VEHICLE DATA LOGS,” the disclosure of which is incorporated by reference herein in its entirety.

### TECHNICAL FIELD

This document relates to unsupervised metadata generation for vehicle data logs.

### BACKGROUND

Some vehicles manufactured nowadays are equipped with one or more types of systems that can at least in part handle operations relating to the driving of the vehicle. Some such assistance involves automatically surveying surroundings of the vehicle and being able to take action regarding detected vehicles, pedestrians, or objects. Such systems are developed in part by collecting significant amounts of data from traveling vehicles. The collected data may initially be characterized as raw data in that it does not include any metadata to describe the type of driving or any events of interest that may have occurred while the data was collected.

One approach for generating metadata for autonomous driving data sets is manual review by human annotators. A human reviewer examines the contents of the data logs, such as video recordings, and flags when relevant criteria are met. This approach is slow and/or requires significant resources. Moreover, the result can be biased by the subjectivity of the person who is performing the review.

As another example, metadata for data sets has been created using trained computer vision models. In this supervised approach, a model trained for a specific set of tasks, such as detecting toll booths or motorcycles, can be run on the recorded video feeds. The detected objects can be recorded for each input video frame. This approach first involves performing advanced training of a machine-learning model, which in turn requires access to a substantial set of annotated vehicle data. As such, using models does not avoid the process of generating metadata for vehicle data sets.

### SUMMARY

In an aspect, a method of performing unsupervised metadata generation for vehicle data comprises: receiving vehicle data collected during travel by a vehicle, the vehicle data including position data, speed data, and timestamps of the position data and the speed data; defining, using the vehicle data, a map route corresponding to the travel in map data; determining metadata for the travel using the map route; and annotating the vehicle data with the determined metadata.

Implementations can include any or all of the following features. The method can further comprise downsampling the position data of the received vehicle data, wherein the downsampled position data is used in defining the map route. The method can further comprise filtering the map data before defining the map route, wherein only remaining map data is used in defining the map route. The filtering is based on a fixed distance from the vehicle during the travel, the fixed distance being substantially perpendicular to a direction of the travel. The method can further comprise upsampling the map data before defining the map route, wherein the map route is defined in the upsampled map data. Determining the metadata comprises reading the metadata from the map data. Determining the metadata comprises calculating the metadata from the map data. The metadata comprises at least one selected from the group consisting of a number of lanes, presence or absence of a highway ramp, presence or absence of a tool booth, a road curvature, traffic data, presence or absence of a bridge, presence or absence of a tunnel, or a road surface material. The method can further comprise presenting at least a portion of the determined metadata in a graphical user interface. The portion of the determined metadata is presented to a human performing annotation of the vehicle data, and wherein presenting the portion of the determined metadata comprises populating an input control in the graphical user interface with the portion of the determined metadata. The method can further comprise determining, using the determined metadata, whether a human should perform annotation of the vehicle data. The method can further comprise making the annotated determined metadata available for selection by a person developing an advanced driver assistance system for the vehicle.

### BRIEF DESCRIPTION OF DRAWINGS

FIG. 1 shows an example of a graphical user interface (GUI) presenting metadata that has been determined for vehicle data.

FIG. 2 shows an example of a GUI of an annotation tool that can use metadata that has been determined for vehicle data.

FIG. 3 shows an example of a GUI of a scene selection tool that can allow a user to choose among vehicle data based on metadata for the vehicle data.

FIGS. 4-7 show example diagrams illustrating unsupervised metadata generation for vehicle data logs.

FIG. 8 schematically shows an example of unsupervised metadata generation for vehicle data logs.

FIG. 9 illustrates an example architecture of a computing device that can be used to implement aspects of the present disclosure.

Like reference symbols in the various drawings indicate like elements.

### DETAILED DESCRIPTION

This document describes examples of systems and techniques that can provide probabilistic map matching for unsupervised metadata generation. The present subject matter can apply map matching to annotate autonomous or otherwise assisted driving data. This can provide a way of determining which data from a sizeable trove of vehicle data collected during driving is of interest for purposes of developing an advanced driver assistance system (ADAS). A scene selector tool can be provided that allows a developer to choose among different driving situations that are reflected in the large vehicle dataset. An ADAS developer who has access to the extensive volume of vehicle data may need to research issues such as where an ADAS algorithm under development performs well or where the algorithm may need improvement; whether a good performance by the ADAS algorithm on the vehicle dataset indicates that feature requirements will be met; or where the ADAS developer should collect more vehicle travel data (e.g., what types of traffic scenes are missing in the present dataset or only sparely represented).

The present subject matter can be associated with one or more of the following advantages. In some implementations, the present subject matter: (i) can automatically review data logs collected by vehicles and determine where events of interest occurred; (ii) can determine metadata for a vehicle data log faster than existing approaches of human annotation, and can avoid the complex training of models associated with supervised approaches; (iii) can allow developers to select specific scenarios from a database, determine whether individual recordings should be reviewed by human annotators, and/or analyze algorithm performance under different road conditions and environmental factors; (iv) can curate vast data sets collected for autonomous driving development; (v) can identify potential logs with rare scenarios more efficiently; or (vi) is not subject to common environmental challenges when working with camera sensors, such as headlight glare or low-light conditions

The present subject matter can operate on vehicle data logs that contain vehicle position data. As used herein, position data includes but is not limited to, satellite-based position coordinates such as Global Positioning System (GPS) coordinates. The system can match the GPS coordinates to the most likely route traversed by the vehicle, where the route data has been extracted from a road network database. A map matching process can take into account probabilistic factors that include the GPS sensor noise, inaccuracies in the road network database, and road connectivity information. The system need not know the vehicle destination or receive direct inputs from the user. The corresponding metadata from the most likely route can be extracted to determine attributes such as the number of driving lanes, road speed limits, and pavement material type. The original map attributes and GPS coordinates can further be used to compute additional metadata fields, such as local road curvature, traffic conditions, and when the vehicle passes by toll booths, bridges, and highway ramps.

A scene selector tool according to the present subject matter can create metadata for raw vehicle data by matching vehicle positions to map data (e.g., an open-source map). Based on the matching, metadata can be automatically retrieved or determined. Such metadata can include, but is not limited to, the presence or absence of tunnels, bridges, toll booths, or ramps; the road curvature or the number of lanes; traffic conditions, pavement material, or speed limits; or dawn/dusk timing, geographical area, or road type, to name just a few examples. According to the present subject matter, map matching can be done using a probabilistic method that determines a most likely sequence of map waypoints that match the vehicle's GPS measurements or other position data. The matching process can take into account one or more relevant factors including, but not limited to, road network connectivity or road-relative vehicle position and heading. When a most probable path has been determined with regard to the map data, attributes of metadata can be extracted from the map and/or computed from the data.

In contrast to the present subject matter, existing consumer navigation applications do not extract and derive metadata information along the traversed route. For example, the present subject matter can consider and record when a vehicle drives past highway ramps. The highway ramp does not need to be a part of the driven route, but the presence of the ramp may suggest interesting road geometry relevant to autonomous driving perception applications.

The present subject matter also differs from road horizon approaches at least in that the metadata extracted by the system can produce more information than the underlying map database. For example, traffic conditions can be estimated based on the vehicle speed relative to the speed limit, or potential low-light conditions can be noted based on the time of sunset at the input GPS coordinates.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons.

Examples herein refer to an ADAS. In some implementations, an ADAS can perform assisted driving and/or autonomous driving. An ADAS can at least partially automate one or more dynamic driving tasks. An ADAS can operate based in part on the output of one or more sensors typically positioned on, under, or within the vehicle (sometimes referred to as the “ego vehicle”). An ADAS can plan one or more trajectories for a vehicle before and/or while controlling the motion of the vehicle. A planned trajectory can define a path for the vehicle's travel. As such, propelling the vehicle according to the planned trajectory can correspond to controlling one or more aspects of the vehicle's operational behavior, such as, but not limited to, the vehicle's steering angle, gear (e.g., forward or reverse), speed, acceleration, and/or braking.

While an autonomous vehicle is an example of an ADAS, not every ADAS is designed to provide a fully autonomous vehicle. Several levels of driving automation have been defined by SAE International, usually referred to as Levels 0, 1, 2, 3, 4, and 5, respectively. For example, a Level 0 system or driving mode may involve no sustained vehicle control by the system. For example, a Level 1 system or driving mode may include adaptive cruise control, emergency brake assist, automatic emergency brake assist, lane-keeping, and/or lane centering. For example, a Level 2 system or driving mode may include highway assist, autonomous obstacle avoidance, and/or autonomous parking. For example, a Level 3 or 4 system or driving mode may include progressively increased control of the vehicle by the assisted-driving system. For example, a Level 5 system or driving mode may require no human intervention of the assisted-driving system.

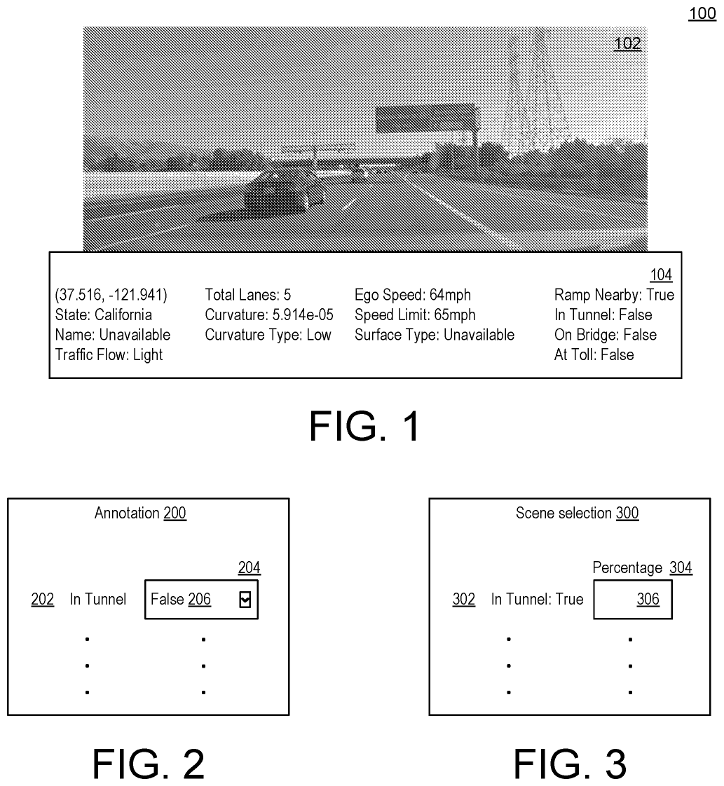

FIG. 1 shows an example of a graphical user interface (GUI) 100 presenting metadata that has been determined for vehicle data. The GUI 100 can be used with one or more other examples described elsewhere herein. The GUI 100 can include a video area 102. In some implementations, the video area 102 can present still or moving images regarding travel undertaken by a vehicle while the vehicle was collecting a data log. For example, the GUI 100 can be used by a human who is reviewing the vehicle data log (e.g., for performing metadata annotation of the vehicle data). Here, the video area 102 shows a view captured in the direction of travel which indicates that the reporting vehicle is currently on a highway (e.g., a road that is part of the U.S. Interstate Highway System).

The GUI 100 includes a metadata area 104 that can at least present one or more types of metadata relating to the vehicle data log. Such metadata may at least in part have been automatically determined using the vehicle data log and other information according to the present subject matter. As another example, the human annotator may enter some metadata or edit any of the metadata provided by the system. The metadata area 104 contains metadata that has been packaged for user consumption. Such packaged metadata can have any of multiple levels of granularity. For example, frame-level metadata (e.g., relating to one or more specific frames of vehicle data (e.g., an image frame) can provide granular labels on when events or transitions occur in the reporting vehicle's travel. As another example, session-level metadata (e.g., relating to the travel session as a whole) can provide general tags suitable for high-level data filtering.

Any type of metadata relating to the vehicle's travel can be presented in the metadata area 104. Here, the metadata includes the following exemplary types of metadata that are applicable to the moment of the vehicle's travel that is currently presented by the GUI 100:
The vehicle's position data (e.g., GPS coordinates),
The number of lanes on the road,
The speed of the reporting vehicle,
Whether there is a highway ramp nearby,
The state in which the reporting vehicle is traveling,
The amount of curvature in the road,
The speed limit of the road,
Whether the reporting vehicle is at a tunnel,
The name of the road,
A curvature type of the road,
A surface type of the road,
Whether the reporting vehicle is on a bridge,
A traffic flow parameter of the road, or
Whether the reporting vehicle is at a toll booth on the road.

Other types of metadata regarding the travel can be used additionally or alternatively.

The metadata presented in the metadata area 104 regarding the reporting vehicle's travel can be determined based on at least vehicle data collected during the travel and map data. In short, the most plausible map route corresponding to the travel can be determined based on map matching, and can be used in extracting the metadata from the map data or otherwise calculating or determining it.

FIG. 2 shows an example of a GUI 200 of an annotation tool that can use metadata that has been determined for vehicle data. The GUI 200 can be used with one or more other examples described elsewhere herein. For example, the GUI 200 can be used for entering and/or editing metadata relating to any or all frames of a vehicle data log relating to a travel session.

The GUI 200 can include at least one metadata description 202. The metadata description 202 can correspond to any metadata of the present subject matter, including, but not limited to, any of the types of metadata mentioned above. For example, the metadata description 202 here indicates that the metadata relates to whether the reporting vehicle is currently located in a tunnel.

The GUI 200 can include at least one input control 204 for the metadata description 202. Any of multiple types of input control compatible with the GUI 200 can be used. For example, the input control 204 provides for making an input by selecting from an existing list (sometimes referred to as a drop-down list). The input control 204 shows a metadata value 206 representing the current input. For example, the metadata value 206 indicates that the metadata of whether the vehicle is currently located in a tunnel presently has the value False (i.e., the reporting vehicle is not currently in a tunnel). Other values, or types of values, can be used.

That is, the GUI 200 can include a significant number of instances of the input control 204 (e.g., at least one instance each for every type of metadata mentioned above). If the user were employing the GUI 200 to annotate a vehicle data log according to the approach used in the past (i.e., without the benefit of the present subject matter), the user may need to enter a value in each of the input controls 204. This can take significant time and may be susceptible to human errors. Here, by contrast, at least one of the input controls 204 can be populated with the metadata value 206 that has been automatically determined according to the present subject matter. For example, the value “False” can automatically be selected (or otherwise entered) in the input control 204. This can allow the user to quickly review the respective metadata values that have been entered, and only make changes if the user believes a different value should be used.

FIG. 3 shows an example of a GUI 300 of a scene selection tool that can allow a user to choose among vehicle data based on metadata for the vehicle data. The GUI 300 can be used with one or more other examples described elsewhere herein. One purpose of the scene selection tool is to allow an ADAS developer to select certain aspects or characteristics of vehicle data from a substantial trove of vehicle logs.

The GUI 300 can include at least one metadata definition 302. The metadata definition 302 can correspond to any metadata of the present subject matter, including, but not limited to, any of the types of metadata mentioned above. For example, the metadata definition 302 here defines the metadata that the reporting vehicle is currently located in a tunnel.

The GUI 300 can include at least one input control 304 for the metadata definition 302. Any of multiple types of input control compatible with the GUI 300 can be used. In some implementations, the input control 304 provides for making an input by specifying (e.g., by typing or selecting) a percentage for the amount of vehicle log data that should be characterized by the metadata definition 302, with a balance of the vehicle log data being specified by another metadata definition, or being unspecified. For example, if the ADAS developer specifies a value 306 using the input control 304, the data retrieved from the vehicle data logs will have an amount corresponding to the value 306 of vehicle log data corresponding to the metadata definition 302. Other parameters than percentage can instead or additionally be used. For example, the user can specify the amount of the data to be retrieved (e.g., by numbers of hours or miles of travel).

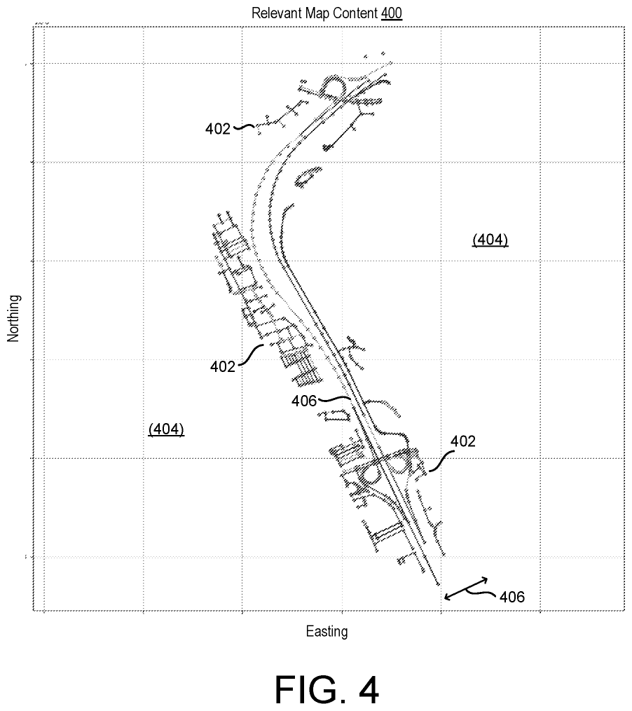

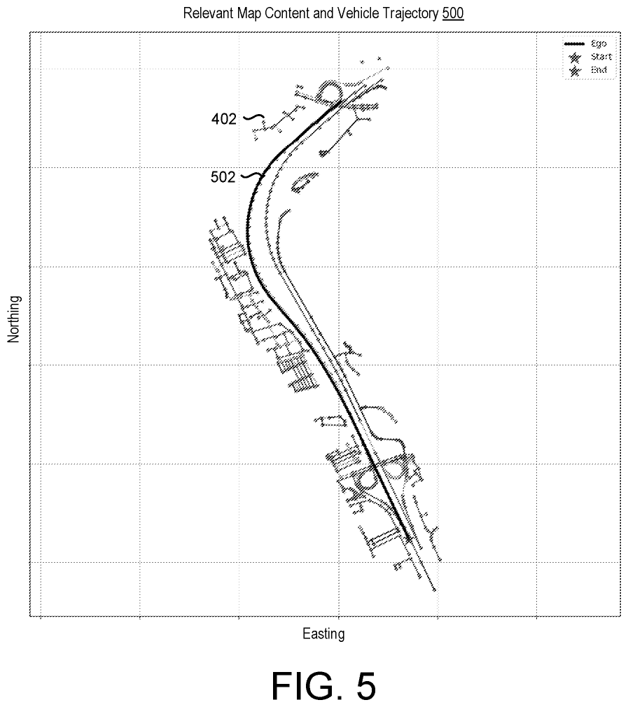

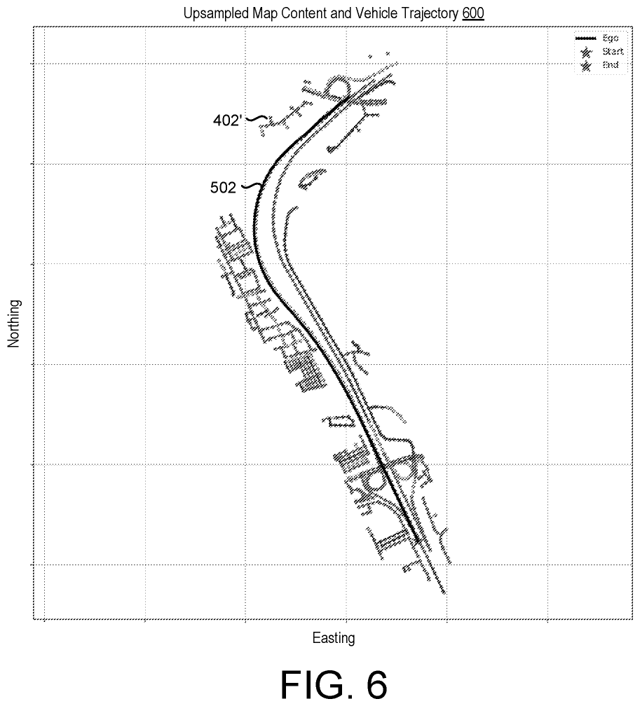

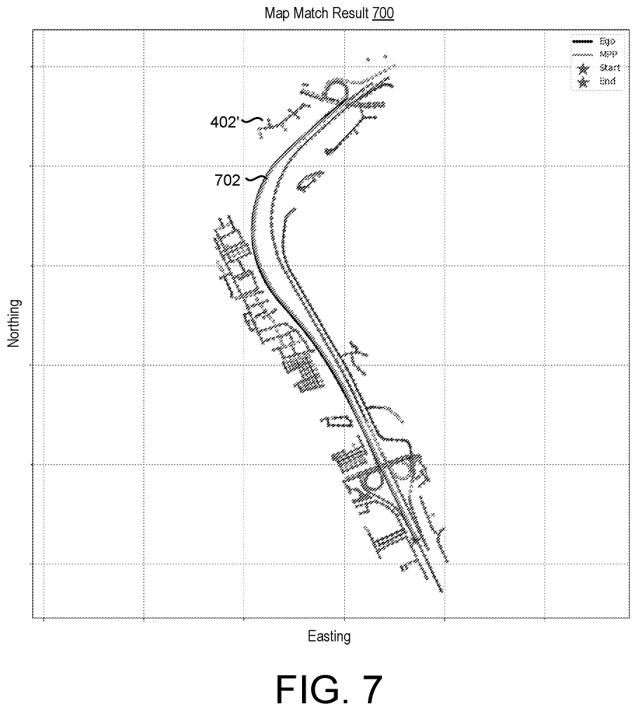

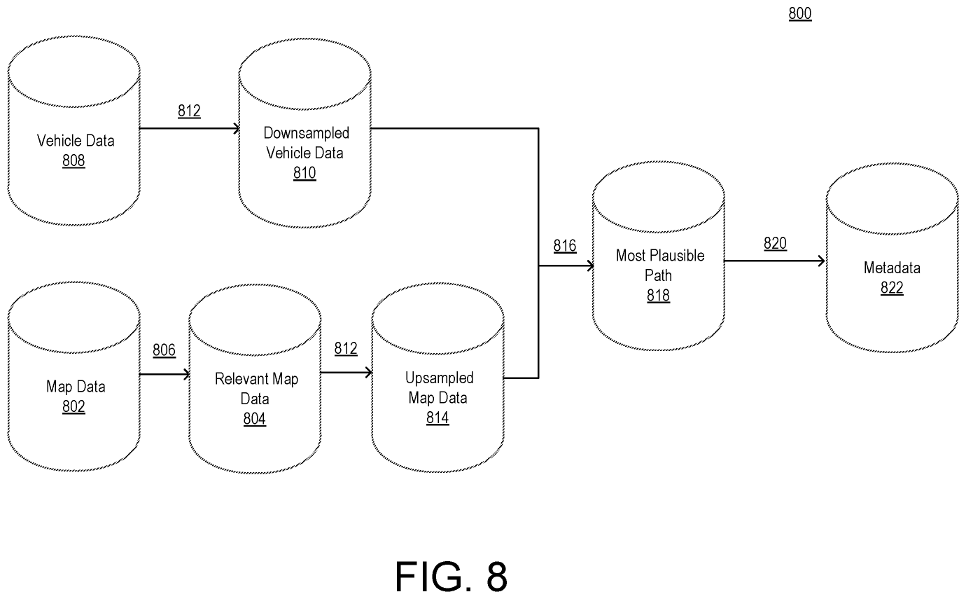

FIGS. 4-7 show example diagrams 400, 500, 600, and 700 illustrating unsupervised metadata generation for vehicle data logs. FIG. 8 schematically shows an example 800 of unsupervised metadata generation for vehicle data logs. Each of these examples can be used with one or more other examples described elsewhere herein.

Each of the diagrams 400, 500, 600, and 700 indicates map positions with regard to a vertical axis labeled Northing and a horizontal axis labeled Easting. Other position coordinates can be used instead or additionally. For example, a transformation can be performed between Northing/Easting and latitude and longitude coordinates of a GPS system.

The map data that the diagrams 400, 500, 600, and 700 may be any of multiple types of map. In some implementations, the map includes standard-definition map data. For example, such map data can represent a multi-lane highway by a single curve in each direction of travel. One benefit of using relatively low-resolution map data is that this data may be almost universally available for all roads of the world, which allows the ADAS development to take into account virtually all locales where vehicles can be expected to travel. In some implementations, the map includes high-definition map data. In either approach, the map data may include waypoints and relatively approximate GPS coordinates, and optionally also some metadata about the map waypoints or other structures.

The original (unfiltered) map content may cover an entire area of the Earth but the reporting vehicle typically only traveled over a part of that map area as a practical matter. Original map data 802 can be filtered based on the position data to generate relevant map data 804 in a filtering operation 806. Here, a region 402 in the diagram 400 is the only map content currently shown in the diagram 400. That is, map content 404 that is part of the original map data is not shown in the diagram 400 because it has been filtered out, and the region 402 is the remaining map data that will be used in defining a map route.

Road network structures and connectivity graphs are created from the filtered map. Such created information can relate to how some or all waypoints of the relevant map data 804 relate to each other. In some implementations, the relevant map data 804 includes definitions of a road as a series of map waypoints, with names given to the start and end points of the series. Such map data may not, however, carry any intuitive sense of which roads of the map data that connect to each other (e.g., as in the case of a highway offramp that attaches somewhere along the length of a highway). Therefore, the map data can be processed to define structures and/or graphs regarding the nature of the roads depicted by the map. This information can be useful because the connectivity is significant as the reporting vehicle crosses between different roads and highways, and also with regard to perception in the context of ADAS development. For example, lane detection or object detection as performed by an ADAS can rely on perception algorithms.

That is, the present subject matter can decode data logs to extract the position data, timestamps, and speed of the reporting vehicle. Filtering out all but the region 402 of the map content can represent a selection of the map content that is relevant to the particular vehicle data being analyzed. As such, the region 402 can be an area of interest created along a trajectory traversed by the vehicle. Such trajectory can be defined using the position data of the vehicle data log. The filtering can be based on a fixed distance from the reporting vehicle during the travel. For example, a fixed distance 406 can be defined as being substantially perpendicular to a direction of the travel of the reporting vehicle. The fixed distance 406 can extend to both sides of the reporting vehicle's position. The region traversed by the fixed distance 406 can then define the region 402. For example, the region 402 can be defined using two-dimensional coordinates (e.g., as a polygon shape).

Here, a trajectory 502 in the diagram 500 represents position data (e.g., GPS coordinates) traveled by the reporting vehicle. In some implementations, the trajectory 502 results from downsampling high-frequency position data to a lower frequency. The downsampling operation 812 can preserve the shape of the reporting vehicle's route while decreasing computational cost. Original position data in vehicle data 808 with a frequency of about 20 per second can be downsampled to position data with a frequency of about one per second in downsampled vehicle data 810 by way of a downsampling operation 812.

The waypoints of the map data (e.g., in the relevant map data 804) can be upsampled. In some implementations, an interpolation can be performed in an operation 812 to generate upsampled map data 814. For example, this can seek to ensure that a minimum spacing guarantee is met. The diagram 600 shows the trajectory 502 with a region 402′ that includes upsampled map content. In some implementations, the contents of the diagram 600 represent the input to a process that seeks to identify the most likely map waypoints for the given route of the vehicle position data.

One or more operations 816 can be performed using the downsampled vehicle data 810 and the upsampled map data 814 to define a most plausible path 818 for the reporting vehicle. In some implementations, probabilistic map matching can be performed. A joint probability distribution can be calculated between the position data of the reporting vehicle and the relevant map data. The road network structures and/or connectivity graphs that were defined for the map data can be taken into account. For example, the probability that the position coordinates for a route point matches a particular waypoint of the map can be maximized. A probabilistic algorithm can be applied to choose the map waypoints that are believed to be the most likely ones given the GPS coordinates or other position data of the reporting vehicle. That is, the most plausible path 818 represents, in terms of the waypoints that were originally obtained from the map data 802, the route that the reporting vehicle most likely traveled. In the diagram 700, a most plausible path 702 is indicated, the most plausible path 702 being defined in terms of map waypoints as opposed to position data (e.g., GPS coordinates obtained from the vehicle log).

The following are specific examples regarding the operation(s) 816. A map matching algorithm can consider the best map waypoints to associate with each downsampled position data (e.g., GPS measurement). The matching process can first remove low probability matches, such as matches that are implausibly far apart or roads in which the reporting vehicle is driving well above the speed limit. For example, if a waypoint is associated with a 25 mph speed limit and the reporting vehicle was currently traveling 80 mph, that tends to make the waypoint less likely to be a match with that position data. The matching algorithm can then give high probability to measurements and map waypoints that are close to one another. The closeness metrics can include multiple heuristics. For example, waypoints above and below an overpass are spatially close to one another but far apart in altitude, road heading, and navigation distance. The most likely sequence of road waypoints given the measurements can be generated from the algorithm. The final solution can be checked by a series of plausibility checks to confirm the algorithm produced a valid result.

The present subject matter can apply probabilistic map matching to annotate autonomous or otherwise assisted driving data. In prior approaches, probabilistic map matching have been used for consumer navigation applications. These applications are typically run from smart phones or similar devices, in which the user requests navigation directions to an input destination. The application must then determine on which road the user resides, and the corresponding route from the starting location to the input destination. As another example, probabilistic map matching has been used in mapping and localization applications for autonomous driving. One common architecture includes systems which determine on which road the vehicle is traveling, and the upcoming road horizon that the vehicle is likely to drive along. Information about the user end destination is not required but can assist the system. These systems report the most likely route and the fields known at the time the road was mapped.

The original map attributes and most likely route are associated together. This provides basic metadata information, such as the name of the roads traversed by the vehicle. The most likely route, road network, and map database can be further processed for more complex metadata fields. Criteria searches around the driving corridor can be applied to check for the presence of toll booths, bridges, highway ramps, and/or other features. Traffic conditions can be assessed by comparing the vehicle speed to the speed limit at the associated waypoint. Local road curvature can be computed from the shape of the most likely route. Dawn, dusk, and other time of day categories can be generated according to the log timestamp and solar events for the relevant geographic locations. Weather data can be obtained based on position data and timestamps. Other approaches for calculating or otherwise determining metadata applicable to the most plausible path 818 can be used in addition or alternatively.

One or more operations 820 of determining metadata 822 for the most plausible path 818 is indicated. In some implementations, the operation(s) 820 involve reading metadata from the map data according to the waypoints of the most plausible path 818. In some implementations, the operation(s) 820 involve calculating the metadata from one or more sources of available information, for example as mentioned above.

The metadata 822 can be used for one or more purposes. In some implementations, the metadata can be provided for use in ADAS development. For example, the GUI 300 in FIG. 3 can allow a developer to choose aspects of vehicle data logs based on the portion(s) of associated metadata. In some implementations, the metadata can be used in deciding whether to perform human annotation of the vehicle data logs. For example, if an ADAS developer is seeking more vehicle log data about driving on tunnels or across bridges, the metadata 822 can be used to determine whether to have a human work on that collected vehicle data in order to label other vehicles with bounding boxes and assign lane markers, etc. In some implementations, the metadata 822 can be used to populate entries in a tool used by a human in categorizing data or entering metadata. For example, one or more values can automatically be entered in the GUI 200 (FIG. 2) to simplify and speed up the work by the user.

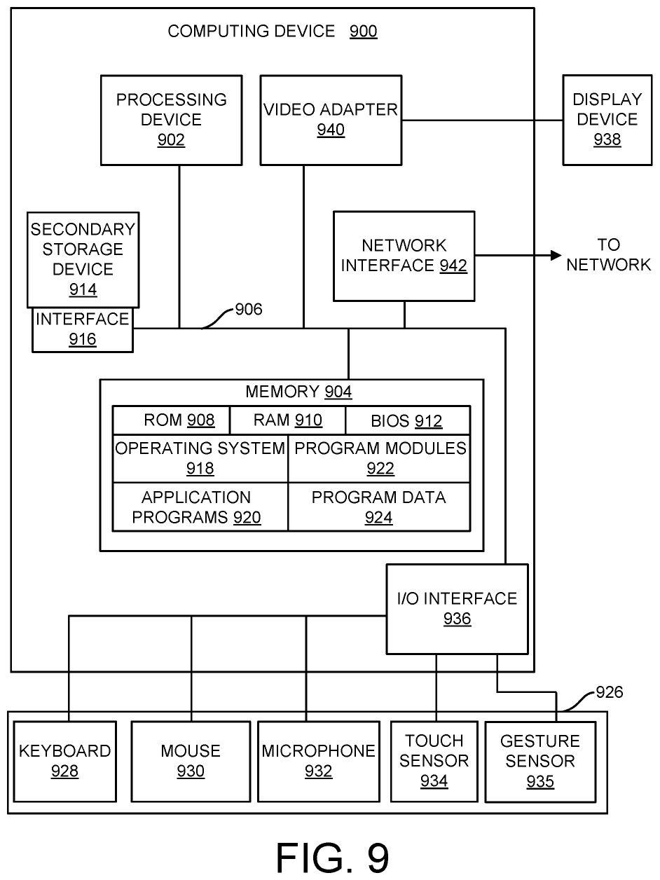

FIG. 9 illustrates an example architecture of a computing device 900 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 9 can be used to execute the operating system, application programs, and/or software modules (including the software engines) described herein.

The computing device 900 includes, in some embodiments, at least one processing device 902 (e.g., a processor), such as a central processing unit (CPU). A variety of processing devices are available from a variety of manufacturers, for example, Intel or Advanced Micro Devices. In this example, the computing device 900 also includes a system memory 904, and a system bus 906 that couples various system components including the system memory 904 to the processing device 902. The system bus 906 is one of any number of types of bus structures that can be used, including, but not limited to, a memory bus, or memory controller; a peripheral bus; and a local bus using any of a variety of bus architectures.

Examples of computing devices that can be implemented using the computing device 900 include a desktop computer, a laptop computer, a tablet computer, a mobile computing device (such as a smart phone, a touchpad mobile digital device, or other mobile devices), or other devices configured to process digital instructions.

The system memory 904 includes read only memory 908 and random access memory 910. A basic input/output system 912 containing the basic routines that act to transfer information within computing device 900, such as during start up, can be stored in the read only memory 908.

The computing device 900 also includes a secondary storage device 914 in some embodiments, such as a hard disk drive, for storing digital data. The secondary storage device 914 is connected to the system bus 906 by a secondary storage interface 916. The secondary storage device 914 and its associated computer readable media provide nonvolatile and non-transitory storage of computer readable instructions (including application programs and program modules), data structures, and other data for the computing device 900 (e.g., a non-transitory computer-readable storage medium).

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 914 and/or system memory 904, including an operating system 918, one or more application programs 920, other program modules 922 (such as the software engines described herein), and program data 924. The computing device 900 can utilize any suitable operating system.

In some embodiments, a user provides inputs to the computing device 900 through one or more input devices 926. Examples of input devices 926 include a keyboard 928, mouse 930, microphone 932 (e.g., for voice and/or other audio input), touch sensor 934 (such as a touchpad or touch sensitive display), and gesture sensor 935 (e.g., for gestural input). In some implementations, the input device(s) 926 provide detection based on presence, proximity, and/or motion. Other embodiments include other input devices 926. The input devices can be connected to the processing device 902 through an input/output interface 936 that is coupled to the system bus 906. These input devices 926 can be connected by any number of input/output interfaces, such as a parallel port, serial port, game port, or a universal serial bus. Wireless communication between input devices 926 and the input/output interface 936 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 938, such as a monitor, liquid crystal display device, light-emitting diode display device, projector, or touch sensitive display device, is also connected to the system bus 906 via an interface, such as a video adapter 940. In addition to the display device 938, the computing device 900 can include various other peripheral devices (not shown), such as speakers or a printer.

The computing device 900 can be connected to one or more networks through a network interface 942. The network interface 942 can provide for wired and/or wireless communication. In some implementations, the network interface 942 can include one or more antennas for transmitting and/or receiving wireless signals. When used in a local area networking environment or a wide area networking environment (such as the Internet), the network interface 942 can include an Ethernet interface. Other possible embodiments use other communication devices. For example, some embodiments of the computing device 900 include a modem for communicating across the network.

The computing device 900 can include at least some form of computer readable media. Computer readable media includes any available media that can be accessed by the computing device 900. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 900.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 9 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 900 can be characterized as an ADAS computer. For example, the computing device 900 can include one or more components sometimes used for processing tasks that occur in the field of artificial intelligence (AI). The computing device 900 then includes sufficient proceeding power and necessary support architecture for the demands of ADAS or AI in general. For example, the processing device 902 can include a multicore architecture. As another example, the computing device 900 can include one or more co-processors in addition to, or as part of, the processing device 902. In some implementations, at least one hardware accelerator can be coupled to the system bus 906. For example, a graphics processing unit can be used. In some implementations, the computing device 900 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method of performing unsupervised metadata generation for vehicle data, the method comprising:
receiving vehicle data collected during travel by a vehicle, the vehicle data including
position data, speed data, and timestamps of the position data and the speed data;
defining, using the vehicle data, a map route corresponding to the travel in map data;
determining metadata for the travel using the map route; and
annotating the vehicle data with the determined metadata.

2. The method of claim 1, further comprising downsampling the position data of the received vehicle data, wherein the downsampled position data is used in defining the map route.

3. The method of claim 1, further comprising filtering the map data before defining the map route, wherein only remaining map data is used in defining the map route.

4. The method of claim 3, wherein the filtering is based on a fixed distance from the vehicle during the travel, the fixed distance being substantially perpendicular to a direction of the travel.

5. The method of claim 1, further comprising upsampling the map data before defining the map route, wherein the map route is defined in the upsampled map data.

6. The method of claim 1, wherein determining the metadata comprises reading the metadata from the map data.

7. The method of claim 1, wherein determining the metadata comprises calculating the metadata from the map data.

8. The method of claim 1, wherein the metadata comprises at least one selected from the group consisting of a number of lanes, presence or absence of a highway ramp, presence or absence of a tool booth, a road curvature, traffic data, presence or absence of a bridge, presence or absence of a tunnel, or a road surface material.

9. The method of claim 1, further comprising presenting at least a portion of the determined metadata in a graphical user interface.

10. The method of claim 9, wherein the portion of the determined metadata is presented to a human performing annotation of the vehicle data, and wherein presenting the portion of the determined metadata comprises populating an input control in the graphical user interface with the portion of the determined metadata.

11. The method of claim 1, further comprising determining, using the determined metadata, whether a human should perform annotation of the vehicle data.

12. The method of claim 1, further comprising making the annotated determined metadata available for selection by a person developing an advanced driver assistance system for the vehicle.

13. A non-transitory computer-readable storage medium having stored thereon instructions which, when executed by at least one processor, causes the at least one processor to perform operations comprising:
receiving vehicle data collected during travel by a vehicle, the vehicle data including
position data, speed data, and timestamps of the position data and the speed data;
defining, using the vehicle data, a map route corresponding to the travel in map data;
determining metadata for the travel using the map route; and
annotating the vehicle data with the determined metadata.

14. The non-transitory computer-readable storage medium of claim 13, wherein the operations further comprise filtering the map data before defining the map route, wherein only remaining map data is used in defining the map route.

15. The non-transitory computer-readable storage medium of claim 14, wherein the filtering is based on a fixed distance from the vehicle during the travel, the fixed distance being substantially perpendicular to a direction of the travel.

16. The non-transitory computer-readable storage medium of claim 13, wherein determining the metadata comprises reading the metadata from the map data.

17. The non-transitory computer-readable storage medium of claim 13, wherein determining the metadata comprises calculating the metadata from the map data.

18. The non-transitory computer-readable storage medium of claim 13, wherein the metadata comprises at least one selected from the group consisting of a number of lanes, presence or absence of a highway ramp, presence or absence of a tool booth, a road curvature, traffic data, presence or absence of a bridge, presence or absence of a tunnel, or a road surface material.

19. The non-transitory computer-readable storage medium of claim 13, wherein the operations further comprise presenting at least a portion of the determined metadata in a graphical user interface.

20. The non-transitory computer-readable storage medium of claim 19, wherein the portion of the determined metadata is presented to a human performing annotation of the vehicle data, and wherein presenting the portion of the determined metadata comprises populating an input control in the graphical user interface with the portion of the determined metadata.
